(19) United States
(12) Patent Application Publication
(10) Pub. No.: US 2026/0200591 A1
(43) Pub. Date: Jul. 16, 2026

(54) ELECTRONIC ACTUATOR HAVING LOW POWER MODE

(71) Applicant: ITT Manufacturing Enterprises LLC, Wilmington, DE (US)

(72) Inventors: David Joseph Caballero, Canoga Park, CA (US); David Brian Welch, Santa Clarita, CA (US)

(73) Assignee: ITT Manufacturing Enterprises LLC, Wilmington, DE (US)

(21) Appl. No.: 19/132,717

(22) PCT Filed: Dec. 1, 2023
(86) PCT No.: PCT/US2023/082016

§ 371 Date: May 23, 2025

Related U.S. Application Data
(60) Provisional application No. 63/429,602, filed on Dec. 2, 2022.

(51) Int. Cl. B64D 41/00; B64D 45/00; B64F 1/35; H02K 7/00; H02K 7/116

(52) U.S. Cl. CPC B64D 41/00; B64D 45/00; B64F 1/35; H02K 7/003; H02K 7/116; B64D 2221/00

(57) ABSTRACT

An electronic actuator includes a housing retaining an electric motor coupled to an output device via a gear train and a circuit enabling a low-power state. In at least one version, one or more switches detect positional limits of the output device and provide a positional detection signal in which the circuit disables all non-essential aspects of the actuator and enables only the positional detection signal while in the low-power mode.

### CROSS REFERENCE TO RELATED APPLICATION

This application claims priority under relevant portions of 35 USC § 119 to U.S. Patent Application Ser. No. 63/429,602, entitled: ELECTRONIC ACTUATOR HAVING LOW POWER MODE, filed Dec. 2, 2022, the entire contents of which are hereby incorporated by reference.

### TECHNICAL FIELD

This application is directed to the field of actuators and more specifically to an electronic actuator for use in aircraft or other suitable applications, in which the actuator is configured with a hibernation or low power (sleep) mode or state. In a preferred version, the actuator includes one or more switches that are configured to detect positional limits of an output device of the actuator, and in which the circuit enables a positional detection signal while in the low power mode. This circuitry is useful in any form of powered aircraft, but can be particularly useful in electric aircraft especially when the aircraft is grounded for extended periods of time.

### BACKGROUND

A number of actuation systems are used on aircraft. For example there are water, fuel and hydraulic valve electrically driven actuators, as well as electrically driven utility actuators, such as linear actuators for utility doors and the like.

In brief, an actuator includes a housing retaining an electric motor and associated gearing, such as, but not limited to a planetary gear train to provide 90 degree or other user-defined rotary actuation of an output device if the actuator is based on rotary output. Similarly, the electric motor and gear train can be used with a linear output device. In any event, travel limits of the output device are detected by corresponding switches that are disposed in relation to the actuator, which are coupled to a controller or similar device attached to a power supply. This detection can also be provided visually, typically by a positional output signal. The electric motor is energized in response to a command signal and de-energized in response to an indication from one of the switches that the travel limit is approaching or has been reached.

These electronic components contain circuitry that consumes a steady quiescent current draw while sitting powered electrically by the aircraft, and idle, at the commanded position of the actuator. This consumption occurs after the actuator has received a command input, been driven to the commanded position, and awaits the next command. This quiescent current is not normally an issue. However, a constant current draw can present a potential issue for aircraft operators, particularly when the aircraft is parked on the ground without the engine running, for extended periods of time. By way of a non-limiting example, this issue could easily materialize in all electric or hybrid aircraft, being powered by a high voltage DC battery bank, given that the battery bank can only provide limited amounts of power. Consuming too much power means the batteries would become depleted sooner.

### BRIEF DESCRIPTION

To address the above-noted concerns and according to at least one aspect of the present invention, there is provided an electronic actuator comprising a housing retaining an electric motor coupled to an output device via a gear train and one or more switches to detect positional limits of the output device and provide a positional detection signal. The actuator further comprises circuitry enabling a low-power mode. The circuitry can be provided within an electronic actuator that powers down to an extremely low-power state, while still providing the needed functionality of the actuator driving the position indication output signal line. According to at least one preferred version, this low power state consumes less than about 500 microamps, which is less than 1/100^{th} of the current draw of an existing actuator design. This functionality can be accomplished by shutting down power to various non-essential functions of the actuator, such as the electric motor control and output shaft position sensing at idle, while at the same time maintaining power to the position indication output of the actuator.

An advantage realized is that of reducing power consumption of actuators, such as those used in aircraft. This advantage is inclusive of both combustion engine and electric powered aircraft. Another realized advantage is that the circuitry can be added as part of a new actuator in manufacture or to an existing actuator in the field.

Other features and advantages will be readily apparent from the following Detailed Description, which should be read in conjunction with the accompanying drawings.

### BRIEF DESCRIPTION OF THE DRAWINGS

FIG. 1(a) and 1(b) are representative views of an exemplary electronic actuator;

FIG. 2 is a schematic diagram of an exemplary circuit for enabling a low power mode in an electronic actuator in accordance with aspects of the present invention;

FIG. 3 is a view of an electronic actuator with its cover removed, illustrating circuitry in the form of a circuit card that can be added for providing low power modality; and

FIG. 4(a) and 4(b) illustrate views of an exemplary circuit card for providing the low power modality.

### DETAILED DESCRIPTION

The following describes an exemplary embodiment of an electronic actuator for use in aircraft, the actuator having circuitry that is suitably equipped to enable a low power or hibernation mode. It will be understood, however, that the herein described circuit can be used for other suitable applications.

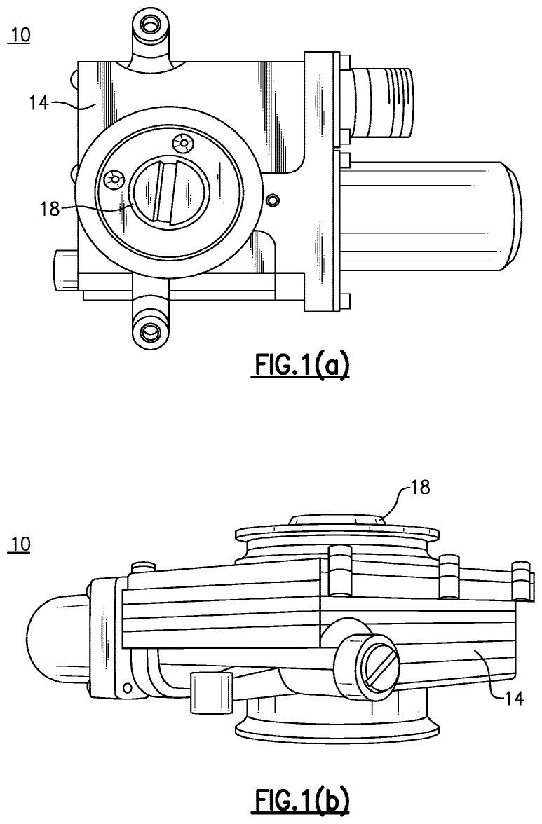

An exemplary electronic actuator in accordance with the present invention is shown in FIG. 1(a) and 1(b). This actuator 10 is defined by a housing or body 14 that retains an electric motor, a gear train and an output device 18. The herein described actuator 10 is a rotary actuator which is dependent on 90 degree output of a drive shaft, partially shown acting as the output device 18, though the herein described concepts are equally applicable to linear actuators and other user-mandated drive shaft outputs. Details relating to the structural aspects of the actuator are provided in U.S. Pat. No. 7,105,801, which is herein incorporated by reference in its entirety. The actuator 10 is commanded between end positions of the drive shaft 18 wherein a positional command signal provides an indication of end of position with switches, i.e., opto-interrupter switches or opto-reflective switches, being disposed to detect end of travel limits and de-energize the electric motor when reached and optionally to provide a positional output signal. In traditional actuators and when fully powered, contained circuitry defined by a H-bridge adapted to energize the motor with a first voltage when the drive shaft 18 is oriented in a first position and to energize the motor with a second voltage, equal in magnitude but opposite in polarity when the drive shaft is oriented in a second position. The controller of the actuator 10 is configured upon sensing of the end of travel to commence dynamic braking of the electric motor, such as by shorting terminals of the electric motor in response to an indication from the corresponding switch and in which the positional signal is further provided at the travel limits of the drive shaft 18.

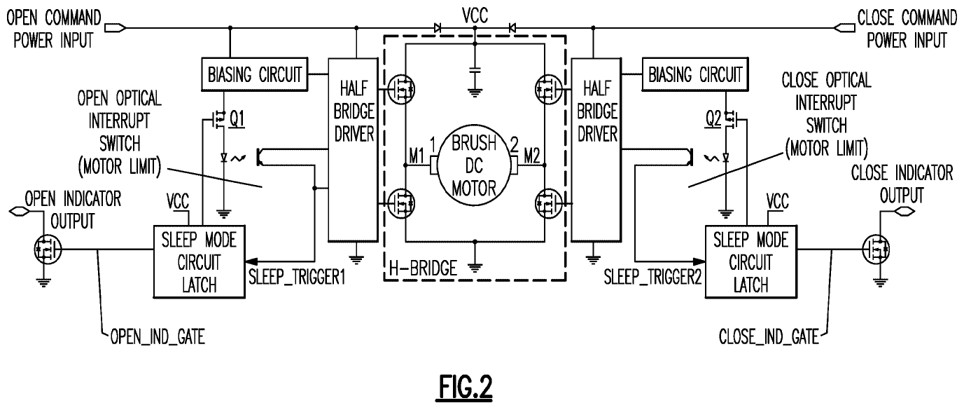

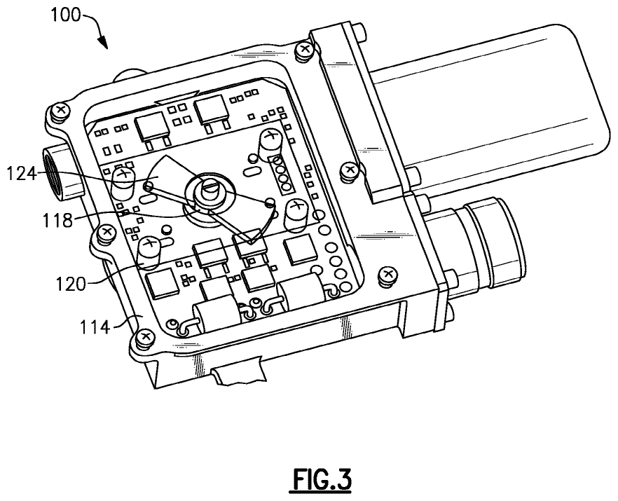

An exemplary low power circuit is shown in FIG. 2 that disables nonessential aspects of the actuator to be powered down during a low power or hibernation mode, but in which the positional indicator signal line is kept active. This mode can be especially useful in electric aircraft, although it should be noted that this low power mode is equally advantageous in combustion engine powered aircraft. A sleep state (low power mode) is active as follows for the Open limit: With further reference to FIG. 3, triggering of a limit position is accomplished using a vane 124, attached to the rotary output shaft 118. Upon reaching the end-of limit travel, the vane 124 will interrupt the open optocoupler, thereby causing a change in state of the phototransistor. Once an open limit indication is triggered, this sleep trigger signal activates a latch in the sleep mode circuitry. Once latched, the output of the sleep mode circuit then biases transistor Q1 off, which removes all nonessential biasing circuitry to the H-bridge, as well as the biasing (position sensing and associated) circuits. At the same time, the indicator positional signal line MOSFET, is kept active with low (sub-milliamp) current to its gate. Power to the H-bridge (electric motor drive of the actuator) is only enabled if power is cycled on with the Open command or the Close command. Once an open indication is triggered by the optocoupler, the gate voltage to the Open indicator rises until it reaches the reference voltage of an open command comparator. This causes the comparator output to rise to the input voltage and removes power to the H-bridge (electric motor drive) as well as the biasing (position sensing and associated) circuits. At the same time, the comparator drives the gate of the open indicator output MOSFET, keeping active with a sub-milliamp current to enable the positional signal line. Power to the H-bridge (electric motor drive) is only enabled if power is cycled on by either the Open command or the Close command.

Similarly, and when a closed indication is triggered by the closed position optocoupler, a sleep trigger signal activates a latch in the sleep mode circuitry. Upon reaching the end-of-limit travel in the closed position, the vane 124, FIG. 3, will interrupt the open optocoupler causing a change of state of the phototransistor. Once a closed limit indication is triggered, this sleep trigger activates a latch in the sleep mode circuitry. Once latched, the output of the sleep mode circuit then biases transistor Q2 off, which removes all nonessential biasing circuitry to the H-bridge as well as the biasing (position sensing and associated) circuits. At the same time, the gate indicator positional signal line MOSFET, is kept active with low (sub-milliamp) current to its gate. Power to the H-bridge (electric motor drive) is only enabled if power is cycled on by either the Open command or the Close command.

According to an alternative version, the circuitry can be configured to power down the actuator and then periodically poll the position sensing circuit. If the actuator is not at the commanded position (open or close), the circuitry would power the H-bridge to move to the commanded position.

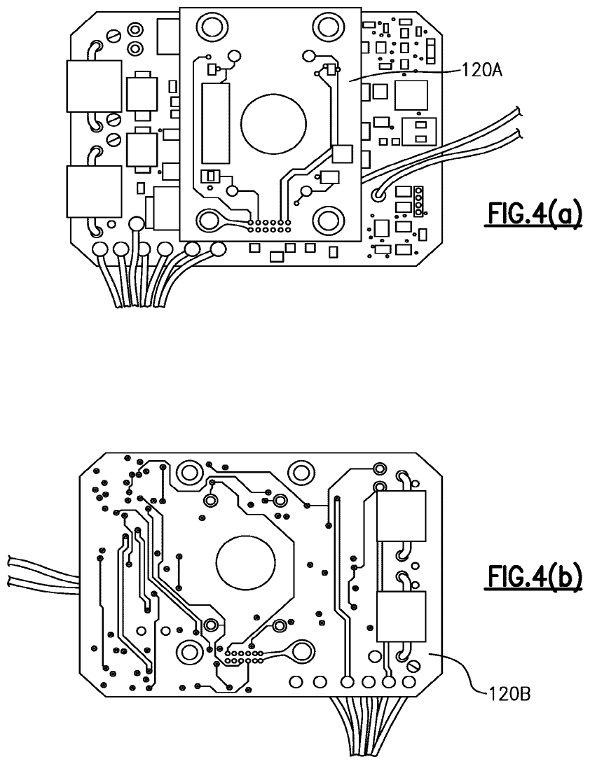

For example, the herein described circuitry 120 can be introduced directly into newly manufactured actuator designs directly within the housing 114 of the actuator 100 or the circuitry may alternatively be introduced into existing actuators as an OEM, each as shown in FIGS. 3-4(b) in which a circuit card 120A, 120B can be added to the interior of the actuator in lieu of existing circuitry provided for the actuator or in combination with already existing circuitry. The modifications to perform this retrofit can be made seamlessly in a time and cost efficient manner and without significantly impacting performance.

It will be apparent that other variations and modifications are possible within the intended scope of this invention, including the following appended claims. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

This Detailed Description uses examples to disclose the invention, including the best mode, and also to enable any person skilled in the art to practice the invention, including making and using any devices or systems and performing any incorporated methods.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### PARTS LIST FOR FIGS. 1-4(b)

10 actuator
14 housing
18 output device (drive shaft)
100 actuator
114 housing
118 drive shaft
120 circuitry
120A circuit card
120B circuit card
124 vane

It will be understood that there are a number of variations and modifications that are intended to fall within the ambits of the herein described invention, including the following appended claims.

1. An electronic actuator comprising:
a housing retaining an electric motor coupled to an output device via a gear train; and
a circuit enabling a low-power state of the actuator.

2. The actuator according to claim 1, further including one or more switches to detect positional limits of the output device and provide a positional detection signal in which the circuit enables the positional detection signal while in the low-power mode.

3. The electronic actuator according to claim 1, wherein the output device is a rotary drive shaft.

4. The electronic actuator according to claim 2, wherein the output device is a linear output device.

5. The electronic actuator according to claim 2, wherein the one or more switches are mechanical.

6. The electronic actuator according to claim 2, wherein the one or more switches are opto-electrical.

7. The electronic actuator according to claim 2, wherein the low power state of the actuator consumes less than about 1 sub-milliamp.

8. The electronic actuator according to claim 1, wherein the actuator is used in aircraft.

9. An electronic actuator comprising:
a housing retaining an electric motor coupled to an output device via a gear train;
one or more switches to detect positional limits of the output device and provide a positional detection signal; and
a circuit enabling a low-power state of the actuator in which the circuit disables all non-essential aspects of the actuator, but enables the positional detection signal while in the low-power state.

10. The electronic actuator according to claim 9, wherein the low power state consumes less than about a sub-milliamp.

11. The electronic actuator according to claim 9, wherein the output device is a rotary drive shaft.

12. The electronic actuator according to claim 9, wherein the output device is a linear output device.

13. The electronic actuator according to claim 9, wherein the one or more switches are opto-electrical switches.

14. The electronic actuator according to claim 9, wherein the actuator is configured for use in aircraft.

15. (canceled)

16. The electronic actuator according to claim 1, comprising a rotatable vane attached to the output device, in which the vane is caused to interrupt an optocoupler when the output device has reached an end of travel limit.

17. The electronic actuator according to claim 16, wherein the interruption of the optocoupler creates the triggering of the low power mode.

18. The electronic actuator according to claim 17, wherein the circuit comprises an H-bridge in which triggering of the low power mode terminates all nonessential circuitry to the H-bridge, but maintains an indicator positional signal line with low power at its gate.

19. The electronic actuator according to claim 9, comprising a rotatable vane attached to the output device, in which the rotatable vane is caused to interrupt an optocoupler when the output device has reached an end of travel limit.

20. The electronic actuator according to claim 19, wherein the interruption of the optocoupler creates the triggering of the low power mode.

21. The electronic actuator according to claim 20, wherein the circuit includes an H-bridge in which the triggering of the low power mode terminates all nonessential circuitry to the H-bridge, but maintains the positional detection signal line with low power at its gate.
